(19) United States
(12) Patent Application Publication
(10) Pub. No.: US 2002/0054370 A1
(43) Pub. Date: May 9, 2002

(54) User notification system used for home delivery locker

(75) Inventor: Kouichiro Hara, Tokyo (JP)

Correspondence Address: ARMSTRONG,WESTERMAN & HATTORI, LLP, 1725 K STREET, NW., SUITE 1000, WASHINGTON, DC, 20006, US

(73) Assignee: Kabushiki Kaisha Fulltime System, Tokyo (JP)

(21) Appl. No.: 09/895,325

(22) Filed: Jul. 2, 2001

(30) Foreign Application Priority Data
Jul. 7, 2000 (JP) P2000-207194

(51) Int. Cl. H04N 1/00

(52) U.S. Cl. 358/436

(57) ABSTRACT

In a user notification system used for a home delivery locker which a home delivery locker and a managing center for managing the home delivery locker are connected through a communication line, and information indicating that the home delivery locker has a parcel is received by the managing center, the system is characterized in that, based upon information of the receiver contained in the information, the managing center or the home delivery locker automatically delivers the parcel delivery information to the receiver through communication means such as telephone (including mobile telephone), facsimile and electronic mail. In the case of a conventional pick-up process of a parcel, it is not possible to confirm whether or not any parcel has arrived, until the receiver has come home and see a notice inside the mail post; therefore, the resulting problem is that, in the case of any urgent parcel, the receiver has to go to the mail box many times to see whether there is any notice therein. The present system makes it possible to solve such a problem.

### BACKGROUND OF THE INVENTION

1. Field of the Invention

The present invention relates to a user notification system used for a home delivery locker, in which a piece of parcel delivery information about a parcel stored in the home delivery locker is given to the corresponding receiver from the home delivery locker or a managing center for managing the home delivery locker through various communication means, or the receiver is allowed to receive the parcel delivery information from the home delivery locker or the managing center through the various communication means.

3. Description of the Related Art

Conventionally, in a condominium or a tenant building, when a parcel is delivered into one of home delivery lockers installed therein, the home delivery person who has brought the parcel puts a notice indicating the number of the corresponding home delivery locker into the mail box of the receiver of the parcel. Then, the receiver, who has got this notice, picks up the parcel from the home delivery locker.

However, in accordance with this conventional method in which, after having got the notice, the receiver picks up the parcel, the receiver is not allowed to know whether a parcel has arrived or not until the receiver has come home and checked the mail box; therefore, in the case when the receiver is out or is sick in bed, he or she is not allowed to know whether a parcel has been delivered or not, and if he or she would like to receive any parcel urgently, he or she has to go as far as the mail box to see whether or not the notice has been put therein many times.

### SUMMARY OF THE INVENTION

The present invention has been devised to solve the above-mentioned problems, and its objective is to provide a user notification system used for a home delivery locker in which a piece of parcel delivery information is given to the corresponding receiver through various communication means virtually simultaneously as the delivery, or the receiver is allowed to get the information through various communication means from the receiver's side.

In order to achieve the above-mentioned objective, the user notification system used for a home delivery locker of the present invention has been devised, and the means in accordance with claim 1, which is provided with: a home delivery locker, and a managing center for managing the home delivery locker, the home delivery locker and the managing center being connected through a communication line so that the managing center is allowed to receive information indicating the fact that a parcel is stored in the home delivery locker, is characterized in that, based upon receiver information contained in the information, a piece of parcel delivery information is automatically delivered from the managing center or the home delivery locker to the receiver through a communication means such as telephone (including mobile telephone), facsimile and electronic mail. The means in accordance with claim 2, is characterized in that the communication means for delivering the parcel delivery information from the managing center or the home delivery locker is limited to one of the communication means that has been preliminarily registered by the receiver in the managing center.

The means in accordance with claim 3, which is provided with: a home delivery locker, and a managing center for managing the home delivery locker, the home delivery locker and the managing center being connected through a communication line so that the managing center is allowed to receive information indicating the fact that a parcel is stored in the home delivery locker, is characterized in that, when the receiver makes a telephone (including mobile telephone) call to the managing center or the home delivery locker and when it has been confirmed that the caller is the preliminarily registered receiver, a piece of parcel delivery information is given through a telephone automatic answering system.

The means in accordance with claim 4, which is provided with: a home delivery locker, and a managing center for managing the home delivery locker, the home delivery locker and the managing center being connected through a communication line so that the managing center is allowed to receive information indicating the fact that a parcel is stored in the home delivery locker, is characterized in that the receiver is allowed to access a site owned by the managing center and identify himself or herself so that the receiver gets a piece of parcel delivery information.

### BRIEF DESCRIPTION OF THE DRAWINGS

FIG. 1 is a block diagram that shows a first preferred embodiment of the present invention; and

FIG. 2 is a block diagram that shows a second preferred embodiment.

### DESCRIPTION OF THE EMBODIMENTS

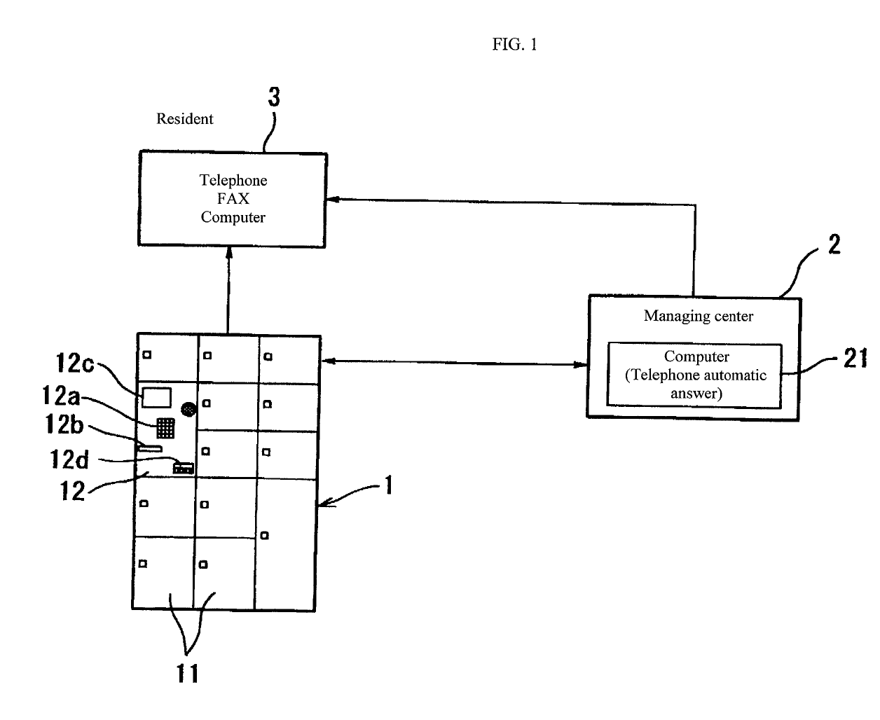

Referring to FIG. 1, an explanation will be given of a first preferred embodiment of a user notification system used for a home delivery locker in accordance with the present invention.

Reference number 1 represents a locker cabinet placed at an entrance of a condominium or a tenant building, etc., which is disclosed by, for example, Japanese Laid-Open Patent Application No. 330458/1997 (Japanese Patent Application Laid-Open No. 9-330458). This locker cabinet 1 is provided with a plurality of lockers 11 having different sizes, and a control box 12 that is operated by a delivery person when the delivered parcel is stored and is also operated by a resident when the parcel is picked up.

This control box 12 is provided with a computer 12, not shown, operation keys 12a, such as ten keys, a card reader 12b that reads a card which the delivery person has preliminarily borrowed from a managing center 2, which will be described later, so as to put parcels into the lockers, a sensor, not shown, which detects the fact that a parcel is housed in the box 11 or that the parcel is picked up out of the locker, a monitor 12c for displaying a sequence of operations, etc., and an electric key, not shown, for locking a door of the locker 11.

Moreover, a printer 12d, which prints a notice and a deposition receipt that show that the delivery person has deposited a parcel, etc., are installed inside the control box 12. Here, the computer, which is connected to a computer in the managing center through a modem and a communication line, has telephone functions, and the computers also have a built-in automatic telephone answering means.

In the home delivery locker 1, the delivery person inserts the borrowed card that he or she carries into the card reader 12b, and also inputs the room number of the delivery end through the operation keys 12a. Here, the computer stores the contents (name of the delivery company, etc.) of the card that have been read by the card reader 12b and the room number of the receiver in its memory. Then, the numbers of some empty lockers, stored in the memory, are displayed on the monitor, and when the delivery person selects the number of a box suitable for the size of the parcel through the operation keys 12a such as ten keys, the door of the corresponding locker 11 in its locked state is opened.

Next, when the delivery person puts the parcel in the box 11 thus opened, the sensor detects the parcel being deposited, and when the door has been closed, the fact that the parcel has been housed is stored in the memory of the computer. Simultaneously with these operations, the printer 12d pints a notice and a deposit receipt out so that the delivery person puts the notice in the mail box corresponding to the room number that has been inputted, and brings the deposit receipt back.

Reference number 2 represents the managing center that manages the home delivery locker cabinet 1, and a computer 21 of the managing center 2 is connected to the computer of the home delivery locker 1 through a communication line; therefore, in the case of a full-time connection, the parcel delivery information of the home delivery locker cabinet 1 is stored in the computer 21 in real time, or the computer 21 accesses the computer of the home delivery locker cabinet 1 so as to retrieve the parcel delivery information.

Reference number 3 represents a communication means owned by the resident, such as a telephone (including a mobile telephone), a facsimile, a computer such as a personal computer, and each resident concludes a contract with the managing center 2 with respect to a desired communication means through which the resident wishes to receive the parcel delivery information when any parcel has been put into a corresponding home delivery locker cabinet 1.

Next, an explanation will be given of the operation of the above-mentioned arrangement. When a piece of parcel delivery information indicating that a parcel has been stored in a locker 11 of the home delivery locker cabinet 1 is inputted to the computer 21 of the managing center 2, or when the computer 21 of the managing center 2 accesses the computer of the home delivery locker 1 to obtain the piece of parcel delivery information, the computer 21 sends the parcel delivery information indicating the deposit of the parcel through the communication means that the corresponding resident designated.

In other words, in the case when the resident has designated the telephone (including mobile telephone), the computer 21 automatically calls the telephone number that has been preliminarily registered to transmit voice information indicating the number of locker in the home delivery locker cabinet 1 in which the parcel is stored, through the telephone automatic answering means. Here, in the case when the resident has designated the facsimile, the computer 21 transmits the corresponding information through its facsimile function, and in the case when the electronic mail has been designated, the parcel delivery information is transmitted to the electronic mail address that has been preliminarily registered.

Moreover, the above explanation has exemplified a case in which the parcel delivery information is transmitted to the corresponding resident through the computer 21 of the managing center 2; however, at the stage in which the parcel delivery information has been stored in the memory of the computer of the delivery locker 1, said computer may transmits the parcel delivery information through the communication means that the resident has designated, in the same manner as the computer 21 of the managing center 2.

In this manner, the resident is allowed to receive the parcel at once through the information transmission from the computer 21 of the managing center 2 or the computer in the home delivery locker 1, and even when the resident is out, he or she is allowed to know the delivery locker cabinet 1 having received his or her parcel by checking the information arrival on his or her mobile telephone, or mobile computer, etc.

In the above-mentioned preferred embodiment, the explanation has exemplified a case in which the parcel delivery information is obtained through the transmission from the managing center 2 or the home delivery locker cabinet 1; however, as shown in the following second preferred embodiment, the resident, that is, the receiver of the parcel, may access the home delivery locker cabinet 1 or the managing center 2 to obtain the parcel delivery information.

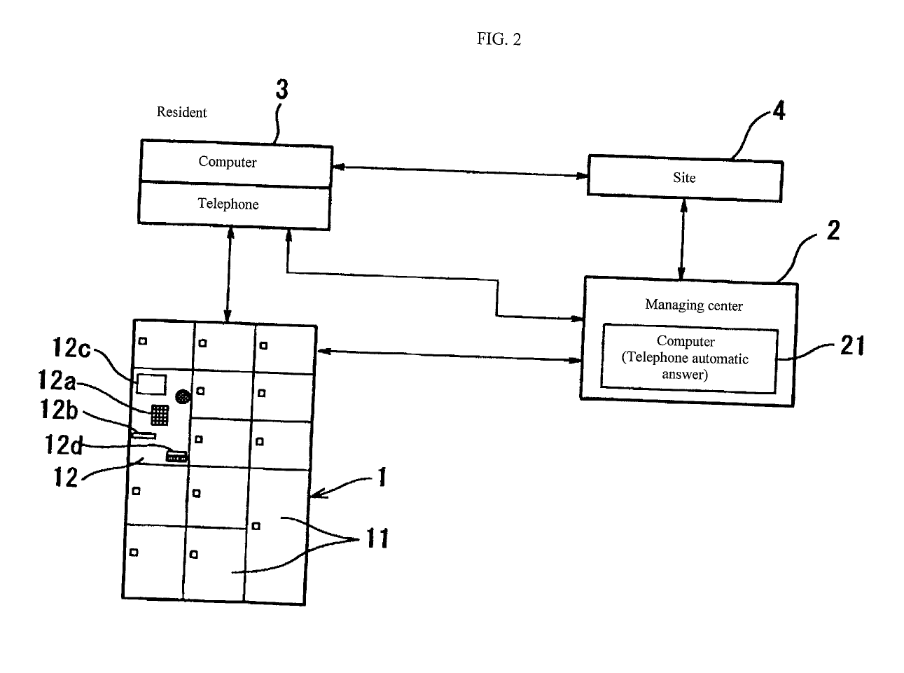

Next, referring to FIG. 2, the following description will discuss a second preferred embodiment; and in this figure, the same reference numbers as used FIG. 1 indicate the same parts, and the description thereof is omitted.

Reference number 4 is a site that is owned by the above-mentioned managing center 2, and this is connected to the Internet, or is a site that can only be accessed by the corresponding residents. Here, it is assumed that the managing center 2 has preliminarily assigned different passwords to the respective residents.

First, when the resident makes a telephone call (including mobile telephone) to the managing center 2 or the home delivery locker cabinet 1, the computer 21 in the managing center 2 or the computer in the home delivery locker cabinet 1, which has received the telephone call, automatically receives the call, and the telephone automatic answering means, built in each of the computers, answers the call.

At this time, the computer makes a judgment as to whether or not the current call is being made from one of the preliminarily registered telephone numbers, and when the judgment shows that the call is being received from said one of the registered telephone numbers, the telephone automatic answering means requests the caller to input a pass word through the telephone. When the resident inputs the pass word, the computer retrieves the parcel delivery information in the home delivery locker cabinet 1 in the condominium where the resident lives so as to check any parcel addressed to the resident, and gives the parcel delivery information to the calling resident through voice. Thus, the resident is allowed to know the parcel delivery information even when he or she is out, or without the necessity of going to the mail box.

In the case when the resident obtains the parcel information by using his or her own computer, the resident accesses anon-line site or a site on the Internet through a communication line, retrieves information from the home delivery locker cabinet 1 in the condominium where he or she lives from the screen on the site, and after the retrieval, inputs a pass word so that the resident is allowed to see the parcel delivery information about the resident's parcel displayed thereon, and to access the corresponding information.

Here, in any of the above-mentioned preferred embodiments, the explanations have exemplified a case in which the home delivery locker cabinet 1 is placed in a condominium or a tenant building; however, the installation site of the home delivery locker 1 is not limited to these places, and it may be installed in any place, such as an individual house. The essential point is that only the registered resident having concluded a contract to use the system with the managing center 2 is allowed to use the system.

As described above, information indicating the fact that a parcel has been stored in a locker is given to the corresponding registered resident from the managing center managing the home delivery locker or the home delivery locker through a communication means; therefore, different from conventional system, the present invention allows the registered resident to positively and easily confirm whether or not any parcel has been delivered, without the necessity of having to go to the mailbox. Moreover, by preliminarily selecting and registering a designated communication means, the resident is allowed to have the parcel delivery information through the desired communication means, for example, his or her mobile telephone.

Moreover, the registered resident may make a telephone call to the home delivery box or the managing center to obtain the parcel delivery information; therefore, even in the case when the registered resident is out, he or she can receive the parcel delivery information. Furthermore, the parcel delivery information is obtained by using a computer process, such as the Internet or on-line; therefore, the resulting effect is that it becomes possible to make a selection among various existing communication means to obtain the parcel delivery information.

What is claimed is:

1. A user notification system used for a home delivery locker, comprising:
a home delivery locker, and
a managing center for managing the home delivery locker, the home delivery locker and the managing center being connected through a communication line so that the managing center is allowed to receive information indicating the fact that a parcel is stored in the home delivery locker,
wherein, based upon receiver information contained in the information, a piece of parcel delivery information is automatically delivered from the managing center or the home delivery locker to the receiver through a communication means such as telephone (including mobile telephone), facsimile and electronic mail.

2. The user notification system used for a home delivery locker according to claim 1, wherein the communication means for delivering the parcel delivery information from the managing center or the home delivery locker is limited to one of the communication means that has been preliminarily registered by the receiver in the managing center.

3. A user notification system used for a home delivery locker, comprising:
a home delivery locker, and
a managing center for managing the home delivery locker, the home delivery locker and the managing center being connected through a communication line so that the managing center is allowed to receive information indicating the fact that a parcel is stored in the home delivery locker,
wherein, when the receiver makes a telephone call to the managing center or the home delivery locker and when it has been confirmed that the caller is the preliminarily registered receiver, a piece of parcel delivery information is given through a telephone automatic answering system.

4. A user notification system used for a home delivery locker, comprising:
a home delivery locker, and
a managing center for managing the home delivery locker, the home delivery locker and the managing center being connected through a communication line so that the managing center is allowed to receive information indicating the fact that a parcel is stored in the home delivery locker,
wherein the receiver is allowed to access a site owned by the managing center and identify himself or herself so that the receiver gets a piece of parcel delivery information.
